(19) United States
(12) Patent Application Publication
(10) Pub. No.: US 2016/0126843 A1
(43) Pub. Date: May 5, 2016

(54) POWER SYSTEM WITH ADAPTIVE CONTROL

(71) Applicant: ZENTRUM MIKROELEKTRONIK DRESDEN AG, Dresden (DE)

(72) Inventor: Anthony KELLY, Old Kildimo (IE)

(73) Assignee: ZENTRUM MIKROELEKTRONIK DRESDEN AG, Dresden (DE)

(21) Appl. No.: 14/889,583

(22) PCT Filed: May 27, 2014
(86) PCT No.: PCT/EP2014/060995

§ 371 Date: Nov. 6, 2015

Related U.S. Application Data
(60) Provisional application No. 61/828,319, filed on May 29, 2013.

(51) Int. Cl. H02M 3/158

(52) U.S. Cl. CPC H02M 3/1584

(57) ABSTRACT

A system includes a plurality of DC-DC converters connected in parallel. Each DC-DC converter of the plurality of converters comprising an adaptive controller is configured to adaptively alter an output resistance of the DC-DC converter by adaptively altering a load line of the DC-DC converter such that a difference between each current being supplied by each DC-DC converter of the plurality of DC-DC converters into a common load is minimized.

### FIELD OF THE INVENTION

The present disclosure relates to a power system with adaptive control and a related method.

### BACKGROUND OF THE INVENTION

In DC-DC conversion it is often convenient to parallel power stages with a common output voltage in order to supply high currents to a load. In this way power conversion can be achieved with scalable and modular components. For example, in point of load (POL) module applications multiple POL modules can be employed in parallel to supply the required current to the load

Traditionally, current share is achieved between parallel converters be means of active or passive methods. In active methods a current share bus is employed between controllers. In passive methods a load-line is usually introduced which can be achieved by introducing a resistor to increase the output resistance of the power converter or by imposing a scheme whereby the voltage setpoint of the converter changes in proportion to the output current

Systems implemented according to passive current share principles often utilize the droop method. Such methods may introduce resistors in order to increase the output resistance of the power converters to improve matching. For example two power converters with a common output voltage would share current, assuming all other things being equal, according to the ratio of their output resistances, so converters with output resistances of 0.1 milli-Ohms and 0.2 milli-Ohms would mismatch by a factor of 2, i.e. 0.2/0.1. But introducing a 1 milli-Ohm resistance into each converter would significantly reduce the mismatch to 1.2/1.1. The additional resistance introduced must be large compared to the output resistance because the value of the output resistance is unknown and therefore it is important that the resistance introduced dominates the original value. Also, the additional resistors increase the power losses in the system and reduce the efficiency. An effective resistance may be implemented in such systems without introducing a physical resistor by introducing a load-line into the controller. In such systems the voltage-setpoint is reduced in proportion to the current being delivered, giving the power converter a larger output resistance (or load-line) without incurring the power losses of a physical resistor.

Passive current share systems, i.e. load-line or droop, do not require a current share bus and therefore can be used when a current share bus is not available or when a slow digital bus is utilized. However, the droop introduced in the output voltage may be unacceptable in many situations because the value of the interconnect resistance is unknown and therefore a large load-line value is required.

Active current share methods are preferred because of losses and/or excessive output voltage deviation incurred in passive methods. Active methods require a current controller in each converter and a current share bus to convey information to all of the parallel converters regarding the required setpoint for the current being controlled by each converter's current loop. An analogue current share bus can react quickly to changes in converter current error, however it can be sensitive to noise. A digital current share bus can be insensitive to noise, but is limited in the transfer rate of data between controllers which limits the reaction time of the current loop leading to excessive mismatch during transients.

Systems implemented according to active current share principles utilize a common current share bus. Usually this is analogue as described in chapter 12 of “Dynamic Analysis of Switching-Mode DC/DC Converters” by Kislovski, Redl and Sokal (1991). Digital systems also exist, for example see “System Modeling and Digital Control in Modular Masterless Multi-phase DC-DC Converters” by Yang, Zane and Maksimovic, Power Electronics Specialists Conference, 2006. However the digital bus speed can lead to significant delays in balancing the currents (see for example FIG. 10 of Yang et. al 2006).

Therefore what is required is a current share system comprising a speed limited digital communication bus operable during current transients.

### DISCLOSURE OF THE INVENTION

This solution is achieved with a system according to the independent system claim and a method according to the independent method claim. Dependent claims relate to further aspects of the present invention.

The present invention relates to a system comprising a plurality of power converters connected in parallel. Each power converter of the plurality of converters comprising an adaptive controller is configured to adaptively alter an output resistance of the power converter by adaptively altering a load line of the power converter comprising an effective resistance and offset voltage such that a difference between each current being supplied by each power converter of the plurality of power converters into a common load is minimized.

The load line of the power converter may be altered such that a difference between each output resistance of each power converter of the plurality of the plurality of power converters is minimized.

For this purpose, each power converter of the plurality of power converters may comprise means for identifying the output resistance of each power converter of the plurality of power converters. Such means may not necessarily identify the parameters explicitly, but may adapt the parameters in order to optimize towards an equal current condition.

Moreover, a negative loadline may be introduced by the adaptive controller, whereby the voltage setpoint increases with current, thereby allowing a negative output resistance for the converter which when utilized in a power system with an interconnect resistance, has the capacity to cancel the interconnect resistance completely such that zero droop is introduced into the final output voltage of the interconnected system.

One aspect of the present invention relates to a digital communication bus that is connecting each adaptive controller of each power converter of the plurality of power converters to each other. The communication bus may be configured to communicate the output resistance of each power converter, the current supplied by each power converter or a current share.

Thus, the system is operable in conjunction with the communication bus conveying information involved in the adaptive system such as average current, estimated resistance or offset voltage or the like. The adaptive controller updates the estimated output resistance at a low rate, e.g. 10 kHz to 100 kHz.

The bus can be configured to communicate additional useful information between converters as well that may indicate status or configuration information between the devices. The system shall be robust versus bus faults because of its adaptive nature.

Operating adaptively, online, and connected by a digital bus, the system of controllers may adjust their load-lines continuously taking information passed between controllers into account to manage the current share and other aspects of power management such as fault, on/off, synchronisation and phase interleaving.

Thus, the power system comprises a current share system allowing parallel power converters to share current on a common output voltage utilizing a digital bus whereby the current control system is operable to control the current during current transients even though the digital bus speed is limited.

Moreover, by use of a digital communication bus, the power converters can communicate fault and status information between one another leading to advantages in reconfiguration and fault management.

The present invention further relates to a method for controlling a system comprising a plurality of power converters connected in parallel. The method comprises identifying an output resistance or an output current of each power converter of the plurality of power converters; communicating the output resistance or the output current of each power converter to each other power converter of the plurality of power converters; and adaptively altering the load line of each power converter such that that a difference between each output current being supplied by each power converter of the plurality of power converters into a common load is minimized and/or such that a difference between each output resistance of each power converter of the plurality of the plurality of power converters is minimized. The method may further comprise communicating a current share to each power converter of the plurality of power converters.

These and other advantages, aspects and novel features of the present disclosure, as well as details of an illustrated embodiment thereof, will be more fully understood from the following description and drawings.

### BRIEF DESCRIPTION OF THE DRAWINGS

Reference will be made to the accompanying drawings, wherein:

FIG. 1 shows a power system comprising a plurality of power converters (POL modules) connected in parallel;

FIG. 2 shows a POL module being a power stage of a buck power converter;

FIG. 3 shows output currents (top) and common output voltage (bottom) of the power system;

FIG. 4 shows a detail of FIG. 3 showing a transient response;

FIG. 5 shows a detail of FIG. 3 showing the performance after the adaption is stopped at 17 ms due to a simulated bus fault;

FIG. 6 shows a block diagram of an adaptive controller;

FIG. 7 shows the estimated output resistance values of the four adaptive controllers starting from the initial value estimate of 0.5 milliohms, adapting according to the estimated value in the circuit and stopping when the fault is introduced.

### DETAILED DESCRIPTION OF THE INVENTION

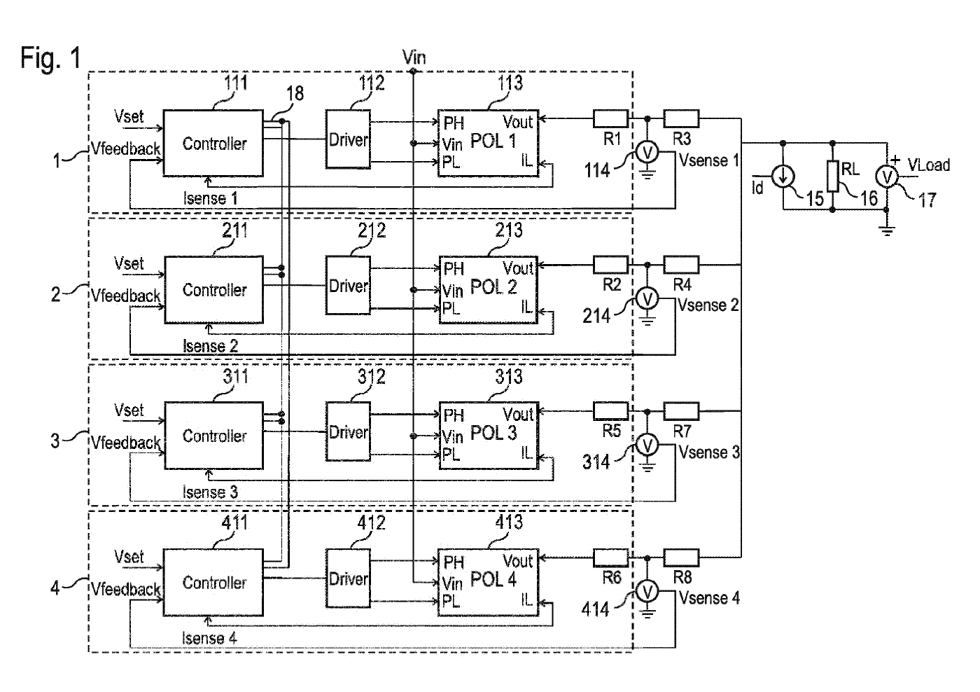

FIG. 1 shows a system comprising a plurality of switched power converters 1, 2, 3, 4 providing power to a common star point load 16. Each power converter 1, 2, 3, 4 comprises a controller 111, 211, 311, 411 for generating a control signal that drives a driver 112, 212, 312, 412. The driver 112, 213, 312, 412 generates a switching signal for switching a switchable power stage 113, 213, 214, 215 that represents a point of load module.

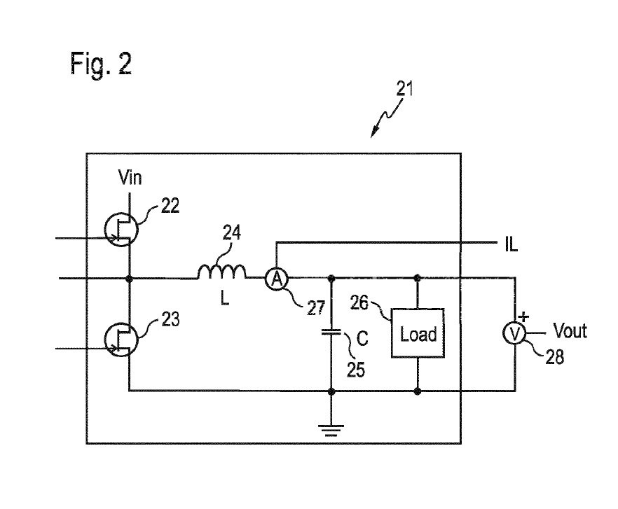

A power stage is shown in detail in FIG. 2. The power stage comprises a dual switching element comprising a high-side switch 22 and a low-side switch 23, an inductor 24 and a capacitor 25 for supplying power to a load 26. The power stage comprises means 27 for measuring the current supplied by the power stage and means 28 for measuring the output voltage.

Returning to FIG. 1, a slow digital communication bus 18 for conveying information between controllers is provided. A load-line (or droop) method but with a considerably lower droop resistance than is feasible in the prior art can be applied.

Considering the output resistances R1, R2, R5, R6 that represent resistances inside the voltage loops and therefore contribute to the closed loop output resistances and the interconnect resistances R3, R4, R7, R8 to a star point load represented by ‘I’ involved in the connection between parallel converter outputs, it can be understood that the most accurate balancing or sharing of currents according to the droop method and minimizing the voltage droop, must involve a knowledge of the entire output resistance including interconnect. In order to achieve this means 114, 214, 314, 414 (28 in FIG. 2) for measuring the output voltages Vsense1, Vsense2, Vsense3, Vsense4 and means for measuring the output currents Isense1, Isense2, Isense3, Isense4 are provided to each of the parallel power converters that estimates the resistance.

Each controller 111, 211, 311, 411 adaptively alters the output resistance and offset voltage of the respective DC-DC converter by altering the load-line of the converter.

The adaptive controller 111, 211, 311, 411 is operable in each converter, adjusting the loadline in order to minimise the difference between the output resistances of the converters and/or equivalently minimise the difference between the currents being supplied by the converters into a common load.

For this purpose, the communication bus 18 is configured to communicate the output resistance of each power converter or the current supplied by each power converter or the current share to each other power converter.

The adaptive controller may operate on principles such as LMS, RLS filters and the like. Also Bayesian update mechanisms may be employed yielding the advantage that information regarding the uncertainty is included in the identification.

Furthermore, the load-line controller is able to introduce a negative loadline whereby the voltage setpoint increases with current, thereby allowing a negative output resistance for the converter which when utilised in a power system with an interconnect resistance, has the capacity to cancel the interconnect resistance completely such that zero droop is introduced into the final output voltage of the interconnected system.

Consider that a load-line in each controller is introduced corresponding to 0.5milli-Ohms and therefore the total mismatch between converters total output resistance corresponds to the difference in R3, 4, 7, 8. If point of load module POL 2 is elected as a “master” then all of the other POL controller's loadlines are desired to adapt until the total resistances are equal and the currents match.

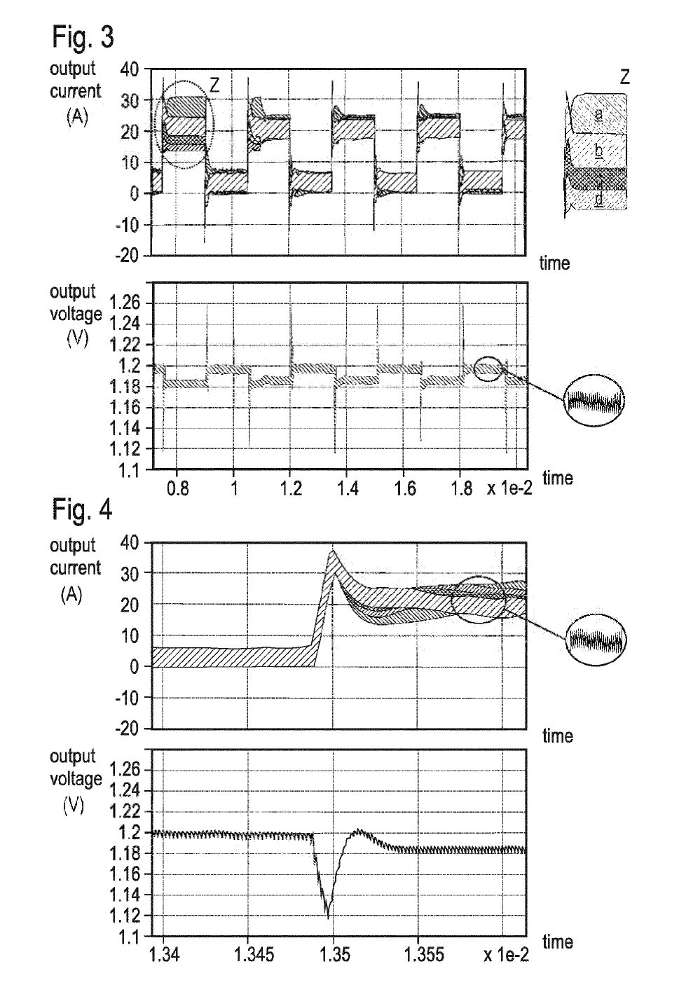

FIG. 3 shows output currents (top) and common output voltage (bottom) of such a system with the adaptive current controller enabled at a time of 11 milli-seconds. It is clear that the initial mismatch is large, but not so excessive to cause a current limit event because of the introduced load line. When the adaptive current controller is enabled it can be seen that the currents are balanced in a desired way to achieve current sharing. It is also clear that the droop in output voltage is reduced when the adaptive system is enabled showing clear advantages compared to a conventional system. At 17 milliseconds a fault is simulated on the current share bus. In response the system does not update the adaptive loop after 17 milli-seconds. It can be seen that the current share is not adversely affected by this fault, and the system is therefore immune to such faults which would be catastrophic in prior-art active current share systems.

The detail of FIG. 3 shown in FIG. 4 illustrates the excellent transient matching achieved in this system, even though the bus speed is limited to 50 kHz in this example.

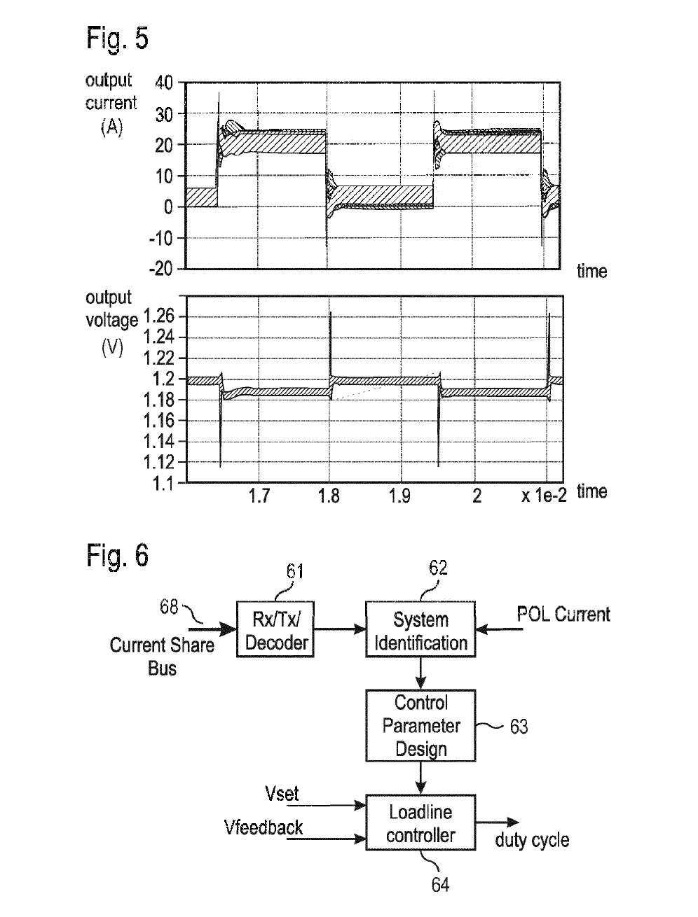

FIG. 5 shows that the performance is not adversely affected by a simulated bus fault at 17 ms that causes the adaptive controller to stop updating.

The model of the adaptive controller is shown in FIG. 6. It comprises a load line controller 64 with adjustable parameters and a means for adjusting the parameters towards the objective. The System Identification block receives the necessary signals such as the device (POL) current and the current share data from current share bus 68 via Rx/Tx-decoder 61 to identify the required parameters of the system. The Control Parameter Design block 63 utilizes the identified parameters to design the control parameters for the loadline controller 64 with the objective of equalizing the currents in connected POLs. The loadline controller represents the Voltage Loop compensator with loadline adjustment.

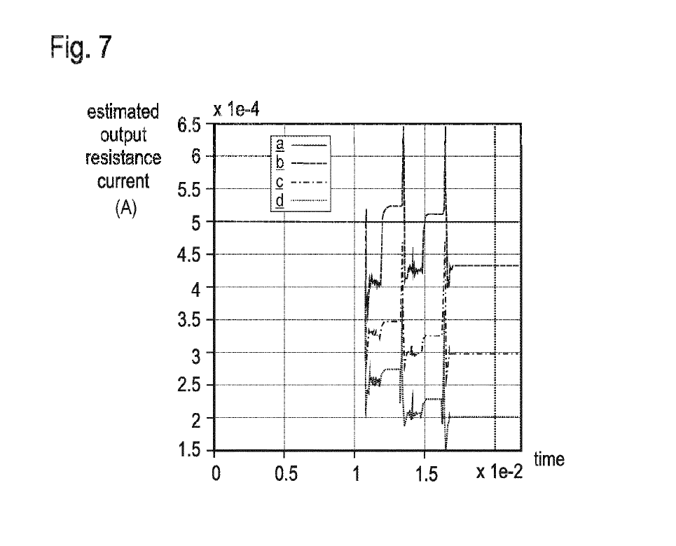

FIG. 7 shows the estimated output resistance values of the four adaptive controllers starting from the initial value estimate of 0.5 milliohms, adapting according to the estimated value in the circuit and stopping when the fault is introduced.

Novel features include an adaptive controller for current share in each power converter. The adaptive controllers can be connected by relatively slow bus. Moreover, there is no need to have closed loop control scheme.

1. System comprising a plurality of DC-DC converters connected in parallel; each DC-DC converter of the plurality of converters comprising an adaptive controller configured to adaptively alter an output resistance of the DC-DC converter by adaptively altering a load line of the DC-DC converter such that a difference between each current being supplied by each DC-DC converter of the plurality of DC-DC converters into a common load and a difference between each output resistance of each DC-DC converter of the plurality of the plurality of DC-DC converters is minimized.

2. (canceled)

3. System according to claim 1, each DC-DC converter of the plurality of DC-DC converters comprising means for identifying the output resistance of each DC-DC converter of the plurality of DC-DC converters.

4. System according to claim 1, wherein the adaptive controller of each DC-DC converter of the plurality of DC-DC converters is configured to adaptively alter the load line of the DC-DC converter such that an interconnect resistance is cancelled completely such that zero droop is introduced into a final output voltage of the system.

5. System according to claim 3, wherein the adaptive controller is configured to introduce a negative load line, whereby a voltage set-point increases with current.

6. System according to claim 1, further comprising a communication bus connecting each adaptive controller of each DC-DC converter of the plurality of DC-DC converters to each other, the communication bus configured to communicate a signal pertaining to each adaptive loop of each adaptive controller.

7. System according to claim 1, further comprising a communication bus connecting each adaptive controller of each DC-DC converter of the plurality of DC-DC converters to each other, the communication bus configured to communicate a current share.

8. System according to claim 1, further comprising a communication bus connecting each adaptive controller of each DC-DC converter of the plurality of DC-DC converters to each other, the communication bus configured to communicate a current supplied by each DC-DC converter.

9. System according to claim 1, further comprising a communication bus connecting each adaptive controller of each DC-DC converter of the plurality of DC-DC converters to each other, the communication bus configured to communicate an output resistance of each DC-DC converter.

10. System according to claim 1, further comprising a communication bus connecting each adaptive controller of each DC-DC converter of the plurality of DC-DC converters to each other, the communication bus configured to communicate an average current supplied by each DC-DC converter.

11. System according to claim 1, further comprising a communication bus connecting each adaptive controller of each DC-DC converter of the plurality of DC-DC converters to each other, and wherein the communication bus is configured to communicate aspects of DC-DC management such as fault, on/off, synchronization and phase interleaving.

12. System according to claim 1, further comprising a communication bus connecting each adaptive controller of each DC-DC converter of the plurality of DC-DC converters to each other, and wherein the communication bus is a digital communication bus.

13. System according to claim 1, wherein the adaptive controller of each DC-DC converter of the plurality of DC-DC converters is configured to adaptively alter the output resistance of the DC-DC converter at a rate between 10 kHz and 100 kHz.

14. Method for controlling a system comprising a plurality of DC-DC converters connected in parallel, comprising:
identifying an output resistance or an output current of each DC-DC converter of the plurality of DC-DC converters;
communicating the output resistance or the output current of each DC-DC converter to each other DC-DC converter of the plurality of power converters; and
adaptively altering a load line of each DC-DC converter such that that a difference between each output current being supplied by each DC-DC converter of the plurality of DC-DC converters into a common load is minimized and such that a difference between each output resistance of each DC-DC converter of the plurality of the plurality of DC-DC converters is minimized.

15. Method according to claim 14, further comprising:
communicating a current share to each DC-DC converter of the plurality of DC-DC converters.
